(19) United States
(12) Patent Application Publication
(10) Pub. No.: US 2013/0293081 A1
(43) Pub. Date: Nov. 7, 2013

(54) CABINET GASKET FOR REFRIGERATOR

(71) Applicant: PAUL B. ALLARD, Stevensville, MI (US)

(72) Inventor: PAUL B. ALLARD, Stevensville, MI (US)

(73) Assignee: WHIRLPOOL CORPORATION, BENTON HARBOR, MI (US)

(21) Appl. No.: 13/462,870

(22) Filed: May 3, 2012

(51) Int. Cl. F25D 23/08; F25D 23/02; B23P 19/04

(52) U.S. Cl. 312/405; 29/428

(57) ABSTRACT

A cabinet gasket is disposed between the cabinet wrapper and cabinet liner in a refrigerator. The cabinet gasket helps reduce thermal conductivity between the cabinet wrapper/mullion and the cabinet liner and refrigerator compartments. The cabinet gasket includes a relatively rigid portion disposed between the wrapper/mullion and the cabinet liner. The cabinet gasket also includes a relatively flexible portion that covers the portion of the wrapper/mullion exposed to the interior of the refrigerator compartments.

### STATEMENT REGARDING FEDERALLY SPONSORED RESEARCH AND DEVELOPMENT

This invention was made with government support under Award No. DE-EE0003910, awarded by the U.S. Department of Energy. The government has certain rights in the invention.

### BACKGROUND OF THE PRESENT INVENTION

The present invention generally relates to a cabinet gasket that is disposed between the cabinet wrapper and cabinet liner in a refrigerator, and more specifically, to a cabinet gasket that helps reduce thermal conductivity between the cabinet wrapper, cabinet liner, and refrigerator compartment.

### SUMMARY OF THE INVENTION

In one aspect of the present invention, a refrigerator includes a cabinet having one or more doors, a cabinet liner defining one or more compartments, and a cabinet wrapper. A cabinet gasket is located between the cabinet wrapper and cabinet liner. The cabinet gasket includes a relatively rigid portion that is located between the cabinet wrapper and cabinet liner and a relatively flexible portion that covers a portion of the cabinet wrapper.

In another aspect of the present invention, a refrigerator includes a cabinet having one or more doors. A cabinet liner defines one or more compartments within the refrigerator. A cabinet wrapper and a mullion overlap the portions of the cabinet liner that would otherwise be exposed when the door is closed. A cabinet gasket is located between the cabinet liner and the cabinet wrapper and mullion, with a relatively flexible portion of the cabinet gasket also covering a portion of the wrapper and mullion.

In yet another aspect of the present invention, a method of assembling a refrigerator includes inserting a cabinet liner into a cabinet to define one or more compartments. A cabinet gasket is inserted between a portion of the cabinet liner and the wrapper that provides the outside surface of portions of the cabinet. One or more doors, with door gaskets, are attached to the cabinet to seal the compartment(s) when the door(s) are in a closed position.

These and other features, advantages, and objects of the present invention will be further understood and appreciated by those skilled in the art upon studying the following specification, claims, and appended drawings.

### BRIEF DESCRIPTION OF THE DRAWINGS

In the drawings:

FIG. 1 is a perspective view of a side-by-side refrigerator;

FIG. 2 is a cross-sectional view of the embodiment of a refrigerator along line II shown in FIG. 1;

FIG. 3 is a cross-sectional view of the embodiment of a refrigerator incorporating a cabinet gasket;

FIG. 4 is a cross-sectional view of the embodiment of a refrigerator along the line IV shown in FIG. 3;

FIG. 5 is a cross-sectional view of the cabinet gasket shown in FIGS. 3 and 4;

FIG. 6 is a cross-sectional view of the embodiment of a refrigerator incorporating an alternative embodiment of a cabinet gasket;

FIG. 7 is a cross-sectional view of the cabinet gasket shown in FIG. 6; and

FIG. 8 is a perspective view of a side-by-side refrigerator with the doors open.

### DETAILED DESCRIPTION OF EMBODIMENTS

For purposes of description herein the terms “upper,” “lower,” “right,” “left,” “rear,” “front,” “vertical,” “horizontal,” and derivatives thereof shall relate to the invention as oriented in FIGS. 1-8. However, it is to be understood that the invention may assume various alternative orientations and step sequences, except where expressly specified to the contrary. For example, while FIGS. 1-8 show certain aspects of a side-by-side refrigerator, the inventive concepts disclosed herein are equally applicable to refrigerators that have one or multiple compartments. Similarly, the inventive concepts are applicable to refrigerators other than side-by-side refrigerators, such as: traditional style refrigerators (with a freezer top and a refrigerator bottom); top refrigerator/bottom freezer style; and French door style refrigerator. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Reference numeral 2 as shown in FIGS. 1-8 generally refers to a refrigerator 2 having a cabinet 4 with one or more compartments 8 and 10. The refrigerator 2 has doors 18 that can be opened to access the compartments 8, 10 or closed to help seal the compartments 8, 10. As shown in FIGS. 1-8, the refrigerator compartment 8 and freezer compartment 10 may be oriented in a side-by-side configuration, with the freezer compartment 10 on either the left or the right.

As shown in FIGS. 1 and 8, the cabinet 4 includes a cabinet wrapper 24. The cabinet wrapper 24 can be made of any material, but typically is a metal material that may be coated and/or textured for durability and aesthetic purposes. The cabinet wrapper 24 provides the exterior surface for most of the cabinet 4. The cabinet wrapper 24 includes a portion 31 that overlaps the cabinet liner 6.

A mullion 22 overlaps the portion 32 of the cabinet liner 6 that defines a wall 23 separating the compartments 8, 10. The mullion 22 can be made of the same or similar material as the cabinet wrapper 24. The mullion 22 is typically a separate piece from the cabinet wrapper 24, but may be integrally formed with the cabinet wrapper as a single-piece structure.

The cabinet liner 6 is located on the interior of the cabinet 4. The cabinet liner 6 can also be made of any material, but typically is a plastic material. The cabinet liner 6 typically defines the refrigerator compartments. In the illustrated example, the cabinet liner 6 defines a refrigerator compartment 8 and freezer compartment 10 in a side-by-side configuration. Each of the compartments may contain one or more shelves 13 and storage areas 26.

The refrigerator 2 includes doors 18 connected to the cabinet 4 by hinges 34 or other suitable means. The doors 18 have door gaskets 20 that help seal the cabinet 4 when the doors are in a closed position. The exterior surfaces 48 of the doors 18 are typically made of the same or similar material as the cabinet wrapper 24. A door liner 50 may be attached to the inside of the doors 18. The door liner 50 will typically be of the same or similar material as the cabinet liner 6. A portion 65 of each exterior surface 48 typically wraps around the edge of the door and underneath a portion of the door liner 50. The door also typically has material such as foam 30 between the exterior surfaces 48 of the doors 18 and the other portions of the door 18 including the door surfaces 65 and the door liner 50. The foam or other material 30 helps to provide durability, structural support, and insulation for the door. One or more shelves 36 or other storage areas 38 may be integrally formed or attached to the door liner 50. Dikes 57 may be formed in the door liner 50 as part of the structure defining the walls of the shelves 36 or storage areas 38. Although not depicted in the drawings, the doors 18 may include other features such as ice makers, water dispensers, and displays.

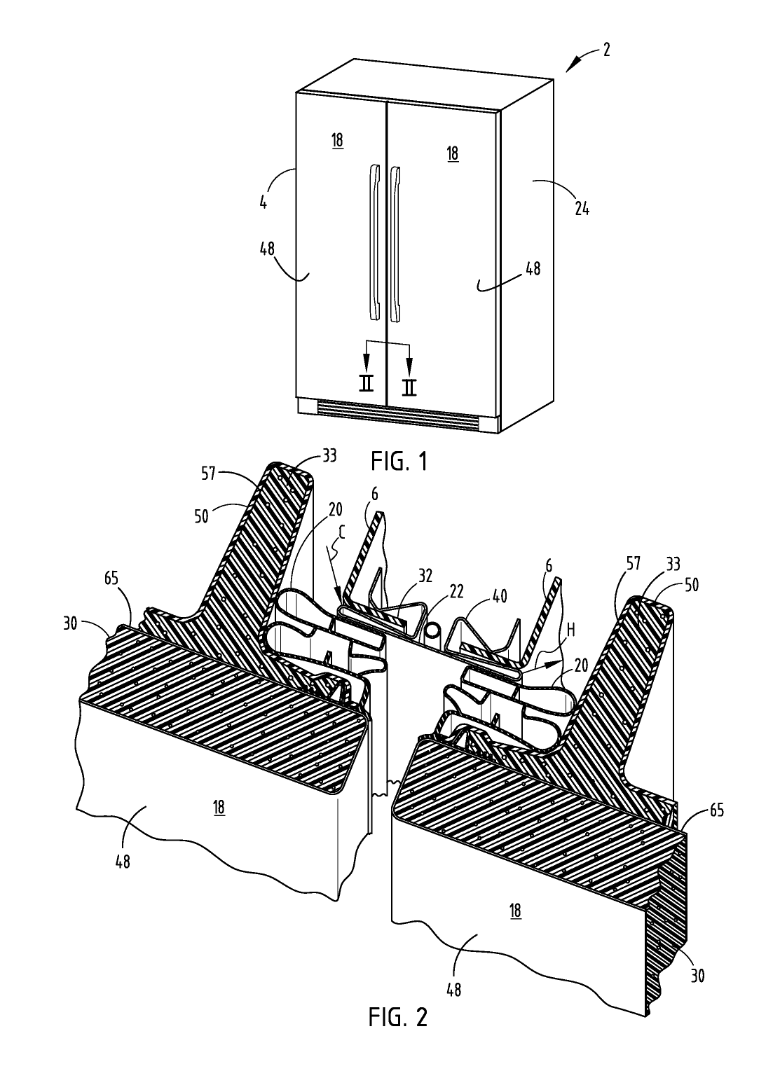

FIG. 2 illustrates a partial cross-sectional view of the side-by-side refrigerator. The door gaskets 20 seal the compartments 8, 10 when the doors 18 are in a closed position. The mullion 22 typically includes a mechanical structure 40 to help connect the mullion 22 to the cabinet liner 6. The mullion 22 is exposed to refrigerator compartment 8 and freezer compartment 10 and allows heat H to more easily enter into the refrigerator compartment 8 and freezer compartment 10. The mullion 22 and the cabinet wrapper 24 can collect heat from the environment, especially when the refrigerator 2 is in an environment warmer than the internal temperature of the refrigerator compartment 8 and freezer compartment 10, such as room temperature. Similarly, the mullion 22 can collect cool air C from the refrigerator compartment 8 and freezer compartment 10. The cooling loss C and/or the addition of heat H from the mullion 22 to the cabinet liner 6 and/or compartments 8, 10 reduces the efficiency of the refrigerator 2. More cooling loss and/or heat gain results in the refrigerator 2 having to draw more energy in order to keep the refrigerator compartment 8 and freezer compartment 10 at the selected temperatures.

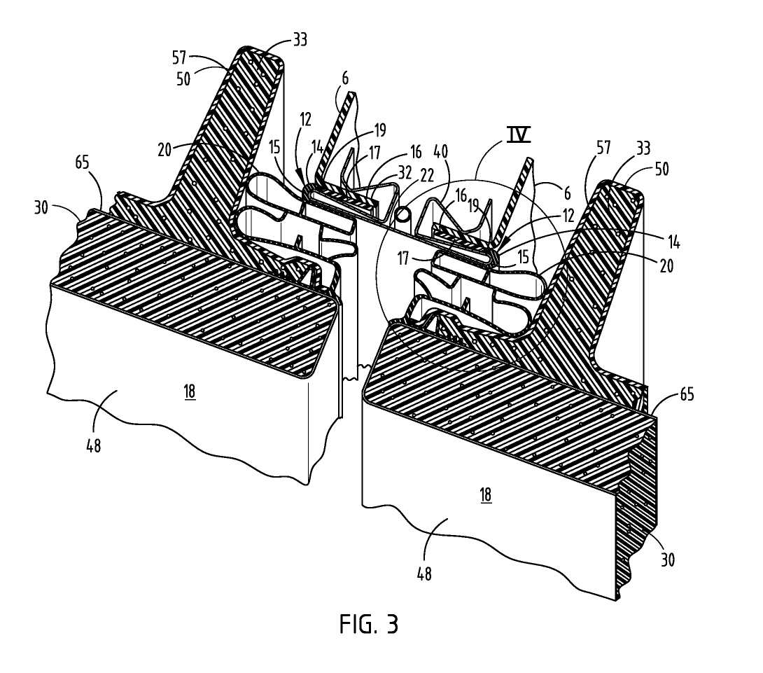

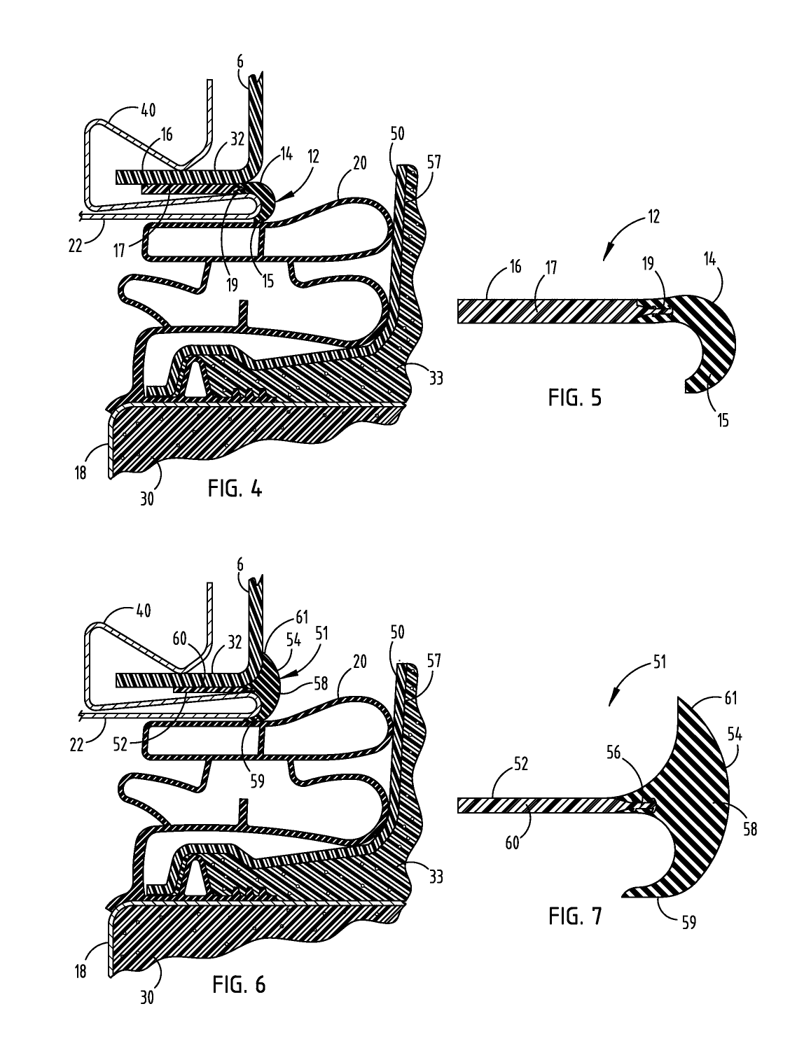

FIGS. 3 and 4 illustrate an embodiment of a cabinet gasket 12 that is inserted in between the mullion 22 and the cabinet liner 6. The cabinet gasket 12 includes a relatively rigid portion 16 and relatively flexible portion 14 as illustrated in FIG. 5. In this illustrated embodiment, the cabinet gasket 12 is formed by extruding a relatively flexible material 15 over a relatively rigid material 17. The relatively rigid material 17 includes a barbed flange 19 over which the relatively flexible material 15 is extruded. The barbed flange 19 provides mechanical support to prevent the relatively flexible portion 14 from being separated from the relatively rigid portion 16. The relatively rigid material 17 may be any relatively rigid material, such as plastic. The relatively flexible material 15 may be any relatively flexible material, such as rubber or TPE.

The relatively rigid portion 16 allows the cabinet gasket 12 to be inserted in between the mullion 22 and cabinet liner 6. The relatively rigid portion 16 and the cabinet liner 6 may be made of the same or similar material. The relative rigidity of portion 16 makes it easier to insert the cabinet gasket 12 between the mullion 22 and the cabinet liner 6 during assembly. The relatively rigid portion 16 of the cabinet gasket 12 also helps thermally insulate the mullion 22 from the cabinet liner 6 thereby helping reduce the addition of heat H to the cabinet liner 6 from the mullion 22.

The relatively flexible portion 14 of the cabinet gasket 12 covers the portion of the mullion 22 that is exposed to the interior of the refrigerator compartment 8 and freezer compartment 10. The relatively flexible portion 14 helps thermally insulate the compartments 8, 10 from the mullion 22, thereby reducing and potentially eliminating a net gain of heat H by the compartments 8, 10 from the mullion 22.

As illustrated in FIGS. 3 and 4, the door gasket 20 and the cabinet gasket 12 can contact and help seal the compartments 8, 10 when the doors 18 are closed.

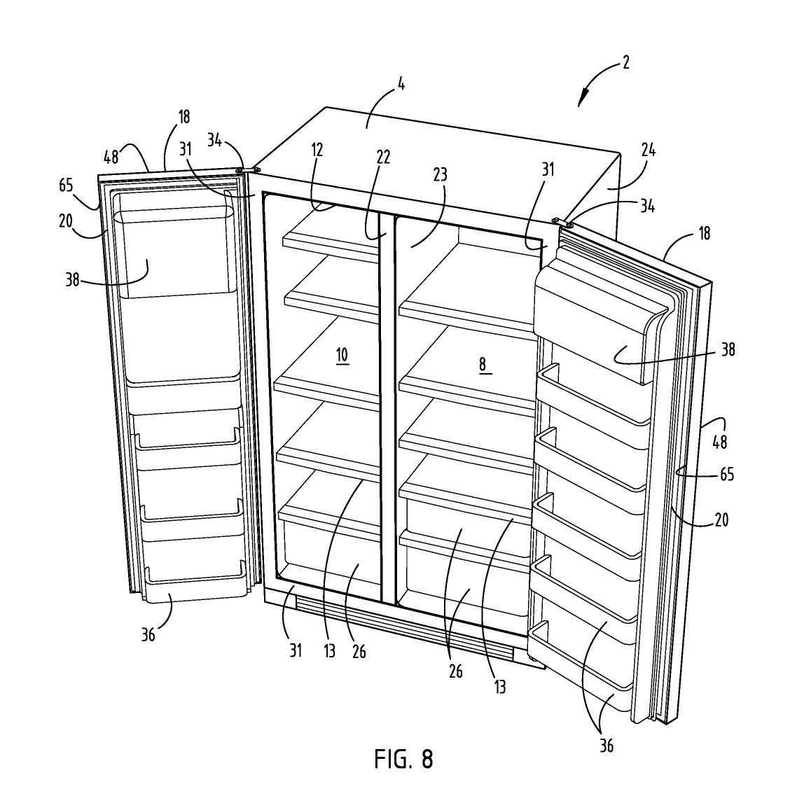

Another embodiment of the cabinet gasket 51 is shown in FIGS. 6 and 7. Cabinet gasket 51 includes a relatively rigid portion 52 having a flange 56 and a relatively flexible portion 54. The cabinet gasket 51 is formed by extruding a relatively flexible material 58 over the relatively rigid material 60 including the flange portion 56. The flange portion 56 may include mechanical structures to help secure the relatively flexible material 58 to the relatively rigid material 60. The cabinet gasket 51 of this embodiment includes a flexible portion 58 that has a portion 59 that covers the surface of the mullion 22 that is exposed to the interior of the compartments 8, 10. The cabinet gasket 51 also has a portion 61 that covers part of the cabinet liner 6. This cabinet gasket 51 also helps seal compartments 8, 10 when the door 18 is in a closed position by engaging the surface of the door gasket 20.

As illustrated in FIG. 8, the cabinet gasket 12 (or 51) can be used not only in the area of the mullion 22, but also around the portion 31 of the cabinet wrapper 24 that wraps over the cabinet liner 6. In this embodiment, the cabinet gasket 12 (or 51) is inserted around the entire periphery of the compartments 8, 10 helping to insulate the compartments 8, 10 from the mullion 22 and wrapper 24 while helping to seal against the door gasket 20 when the doors 18 are in a closed position.

It will be understood by one having ordinary skill in the art that construction of the described invention and other components is not limited to any specific material. Other exemplary embodiments of the invention disclosed herein may be formed from a wide variety of materials, unless described otherwise herein.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

The above description is considered that of the illustrated embodiments only. Modifications of the invention will occur to those skilled in the art and to those who make or use the invention. Therefore, it is understood that the embodiments shown in the drawings and described above is merely for illustrative purposes and not intended to limit the scope of the invention, which is defined by the following claims as interpreted according to the principles of patent law, including the Doctrine of Equivalents.

1. A refrigerator, comprising:
a cabinet having at least one door with a door gasket disposed on the door;
a cabinet liner that defines at least one compartment within the cabinet;
a cabinet wrapper that overlaps portions of the cabinet liner; and
a cabinet gasket that has a substantially flexible portion covering a portion of the cabinet wrapper and a substantially rigid portion that is located between a second portion of the cabinet wrapper and the cabinet liner;
wherein the cabinet gasket is configured to engage the door gasket when the door is in a closed position.

2. The refrigerator of claim 1, wherein the cabinet liner is plastic.

3. The refrigerator of claim 2, wherein the cabinet wrapper is metal.

4. The refrigerator of claim 1, wherein the cabinet gasket is extruded in two materials, one being a substantially flexible material and the other a substantially rigid material.

5. The refrigerator of claim 4, wherein the substantially rigid material is disposed between the cabinet liner and the cabinet wrapper and wherein the portion of the cabinet wrapper covered by the substantially flexible material prevents complete exposure of the cabinet wrapper to an interior of the compartment.

6. The refrigerator of claim 4, wherein the substantially flexible material is rubber or TPE.

7. The refrigerator of claim 4, wherein the substantially rigid material is plastic.

8. The refrigerator of claim 1, wherein the cabinet gasket is located between the cabinet wrapper and cabinet liner along the entire periphery of a compartment.

9. A refrigerator, comprising:
a cabinet having at least one door with a door gasket disposed on the door;
a cabinet liner that defines a plurality of compartments within the cabinet;
a mullion that overlaps a portion of the cabinet liner between two adjacent compartments; and
a cabinet gasket located between the cabinet liner and mullion having a substantially flexible portion that covers a portion of the mullion and is configured to engage the door gasket when the door is in a closed position.

10. The refrigerator of claim 9, wherein the cabinet liner includes a plastic material.

11. The refrigerator of claim 10, wherein the mullion includes a metal material.

12. The refrigerator of claim 9, wherein the cabinet gasket is integrally formed from two different materials.

13. The refrigerator of claim 9, wherein the cabinet gasket contacts a portion of a door gasket when the door is in a closed position.

14. A method of assembling a refrigerator, comprising:
inserting a cabinet liner into a cabinet having a wrapper to define at least one compartment;
inserting a cabinet gasket between a portion of the cabinet liner and the wrapper; and
attaching at least one door with a door gasket to the cabinet such that the door gasket contacts the cabinet gasket to seal the compartment when the door is in a closed position.

15. The method of claim 14, further comprising:
forming a substantially rigid portion on the cabinet gasket that is inserted between the cabinet liner and the wrapper.

16. The method of claim 15, further comprising:
forming a substantially flexible portion on the cabinet gasket that covers a portion of the wrapper thereby preventing exposure of a portion of the wrapper to an interior of the compartment.

17. The method of claim 16, further comprising:
forming the substantially flexible portion on the cabinet gasket to contact the door gasket thereby sealing any gaps between the cabinet and the door when the door is in a closed position.

18. The method of claim 14, further comprising:
forming the cabinet gasket by extruding a flexible material onto a substantially rigid material.

19. The method of claim 14, further comprising:
inserting a mullion into the cabinet liner.

20. The method of claim 19, further comprising:
inserting the cabinet gasket around the entire periphery of a compartment between the cabinet liner and both the wrapper and mullion.
